(19) United States
(12) Patent Application Publication
(10) Pub. No.: US 2010/0304105 A1
(43) Pub. Date: Dec. 2, 2010

(54) Fabric

(76) Inventor: Andrew Nasarczyk, Victoria (AU)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/086,732

(22) PCT Filed: Oct. 30, 2006
(86) PCT No.: PCT/AU2006/001607

§ 371 Date: Nov. 10, 2008

(30) Foreign Application Priority Data
Dec. 19, 2005 (AU) 2005907118

(51) Int. Cl. B32B 7/02; B32B 27/12; B32B 37/00; B32B 37/02

(52) U.S. Cl. 428/216; 442/38; 156/60

(57) ABSTRACT

A fabric includes a woven plastic base layer, a first coating layer including a plastic applied to one side of the woven plastic base layer, and a second coating layer including a plastic applied to the other side of the woven plastic base layer. The fabric further includes a first exterior layer including a plastic applied to the first coating layer, and a second exterior layer including a plastic applied to the second coating layer.

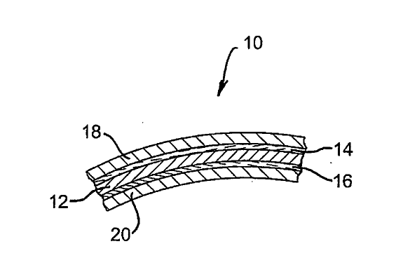

### BACKGROUND OF THE INVENTION

1. Field of the Invention

The present invention relates broadly to a new fabric. More particularly, the present invention relates to a fabric for use in impervious applications such as fluid storage applications and will generally be described in this context. However, it is to be appreciated that the present invention may be used in a wide variety of other applications.

Hereinafter, reference to ‘fluid’ is to be understood to include reference to any practical liquid, gas or combination thereof.

2. Description of the Related Art

Existing fluid containment solutions are generally provided in the form of rigid-walled containers. While such containers capably store liquid and/or gas, the use of rigid-walls can limit the range of applications possible with such containers.

Attempts have been made to create flexible walled or semi-flexible walled fluid storage containers. Unfortunately, however, the fabric used in the manufacture of such containers isn't generally sufficiently flexible for use in a number of desired fluid storage applications. Moreover, such containers generally aren't sufficiently impervious to fluids for use in fluid storage applications and/or tend to deform under the levels of pressure involved in storing some fluids, especially liquids.

Another problem with existing fabric for use in fluid storage applications is that the fabric has been found to taint or otherwise pollute the fluid being stored because of the migration of various fabric constituents into the fluid.

It would thus be desirable to provide a generally impervious fabric. More particularly, it would be desirable to provide a generally impervious fabric for use in the storage of fluids. Further, it would be desirable to provide a fabric that generally will not deform under the levels of pressure involved in storing liquids. It would also be desirable to provide a flexible or at least semi-flexible fabric for the storage of fluids. It would further be desirable to provide a fabric which, in practical terms, won't taint or otherwise pollute the fluid being stored by a container constructed from that fabric.

### SUMMARY OF THE INVENTION

According to a broad aspect of the present invention, there is provided a fabric. The fabric comprises a base layer including a woven plastic, a first coating layer applied to one side of the base layer and a second coating layer applied to the other side of the base layer. Each of the first coating layer and second coating layer comprises a plastic. The fabric comprises a first exterior layer applied to the first coating layer and a second exterior layer applied to the second coating layer. Each of the first exterior layer and second exterior layer comprises a plastic. The base layer comprises a multi-filament scrim.

In a preferred form, the woven plastic of the base layer comprises a woven polymer.

Preferably, the base layer comprises polypropylene. Indeed, the base layer may comprise polypropylene as a substantial component. However it is to be appreciated that other polymers and co-polymers may be suitable, depending on the application of the fabric.

The base layer may comprise a multi-filament scrim using fibre in the range of approximately a 600 denier fibre to approximately a 2000 denier fibre, in anything from about a 4×4 to about a 10×10 yarns/cm weave pattern. One non-limiting example of a suitable scrim for use in the base layer of the present invention is a multi-filament scrim using a 1000 denier fibre in a 5×5 yarns/cm weave pattern.

The base layer may comprise a non-wicking additive, such as a wax. A colour additive may also be added to the base layer.

The fabric may be used in applications in which it is exposed to sunlight or other potentially harmful light source, in which case a UV stabilizer additive may be to included in the base layer. A heat stabilizer additive may also be included in the base layer, which can be of particular benefit when the fabric is to be exposed to heat, such as when the fabric is used as a water tank liner.

In a preferred form, the plastic in each of the first coating layer and second coating layer comprises a polymer and, in one form, each coating layer comprises a composite polymer of polyethylene and polypropylene.

The first coating layer and second coating layer may be co-extruded.

The thickness of each of the first and second coating layers may be selected to suit a particular application. In a preferred form, however, each of the first and second coating layers has a thickness of between approximately 40 microns and approximately 120 microns. More preferably, each of the first and second coating layers has a thickness of approximately 70 microns.

Preferably, the plastic in each of the first and second exterior layers comprises a polymer. The polymer may comprise polypropylene. More particularly, the polymer may comprise polypropylene as a substantial component.

Colour additive(s) may be added to each of the first and second exterior layers. The colour additive added to each of the exterior layers may be the same. However, in some applications it may be desirable for the exterior layers to be a different colour. In still other applications, it may be desirable for one of the exterior layers to be, for example, black and the other exterior layer to be transparent, such that the colour of the adjacent coating layer may be seen through the transparent exterior layer. One particularly preferred colour of the coating layer in such an application is green, with the green colour visible through the transparent exterior layer.

One or both of the exterior layers may comprise a UV stabilizer additive.

The thickness of each of the first and second exterior layers may be selected to suit a particular application. In a preferred form, the thickness of each of the first and second exterior layers is between approximately 40 microns and approximately 120 microns. In a more preferred form, the thickness of each of the first and second exterior layers is approximately 70 microns.

One intended application for the fabric of the present invention is as a fluid retaining fabric. In such an application, the fabric preferably comprises an additive to inhibit migration of any of the layer constituents from the fabric and into the fluid being retained.

Any suitable manufacturing processes and/or technique(s) may be used to manufacture the fabric. Existing bonding techniques may be employed to seal the fabric at appropriate locations to, for example, create fluid storage containers or other required seals.

Two or more of the fabric layers may be laminated together in a single pass, thereby potentially substantially reducing the number of separate passes that may be required to produce the fabric.

It will be convenient to hereinafter describe a preferred embodiment of the invention with reference to the accompanying drawing. The particularity of the drawing is to be understood as not limiting the preceding broad description of the invention.

### BRIEF DESCRIPTION OF THE DRAWING

The FIGURE is a sectional view of the fabric.

### DETAILED DESCRIPTION OF THE INVENTION

Referring to the FIGURE, there is illustrated a fabric 10. The fabric 10 comprises a flexible base layer 12 comprising a woven polymer plastic. The polymer plastic comprises polypropylene as a substantial component. More particularly, the base layer 12 is a multi-filament scrim using a 1000 denier fibre in a 5×5 yarns/cm weave pattern.

The base layer 12 comprises a non-wicking additive, such as a wax, a colour additive and a UV stabilizer additive.

A first flexible coating layer 14 is applied to one side of the base layer 12 and a second flexible coating layer 16 is applied to the other side of the base layer 12. The first and second coating layers 14, 16 are co-extruded.

Each of the first coating layer 14 and second coating layer 16 is, in fact, three distinct layers (not clearly illustrated). The first of these three layers, bonded directly to the base layer 12, is predominantly a polypropylene copolymer having a thickness of approximately 25 microns. The next layer, or middle layer of the three layers, is a composite layer of polypropylene and polyethylene. A compatabilizer is added to this layer in order to combine the polypropylene and polyethylene. The thickness of this layer is approximately 25 microns. The third, predominantly low-density polyethylene layer has a thickness of approximately 20 microns. This third layer is bonded to (one of) the exterior layers 18, 20. Thus, the thickness of each of the first coating layer 14 and second coating layer 16 is approximately 70 microns.

It is to be appreciated that the coating layers 14, 16 are mirror images of one another.

The first exterior layer 18 is in the form of a film applied to the first coating layer 14, and the second exterior layer 20 is in the form of a film applied to the second coating layer 16. Each of the first exterior layer 18 and second exterior layer 20 comprises polyethylene as a substantial component.

The first coating layer 14 is provided primarily to bond the first exterior layer 18 to the base layer 12. Likewise, the second coating layer 16 is provided primarily to bond the second exterior layer 20 to the base layer 12.

The thickness of each of the first exterior layer 14 and second exterior layer 16 is approximately 70 microns.

Colour additive(s) are added to each of the first and second exterior layers 18, 20. The colour additive added to each of the exterior layers 18,20 may be the same. However, in the illustrated example, the first exterior layer 18 is black and the second exterior layer 20 is transparent, such that the green coating layer 18 may be seen therethrough.

The exterior layers 18,20 comprise a UV stabilizer additive.

The exterior layers 18,20 also comprise a matting additive. The matting additive imparts a matt finish to the exterior layers 18,20. The inclusion of a matting additive is particularly beneficial, for example, when the fabric 10 is manufactured into a water tank liner for use in a water tank that may not be fitted with a lid or cover. The matt finish limits the amount of sunlight incident on one portion of the inner surface of such a liner being focussed onto another portion of the liner and thereby burning or otherwise damaging the structural integrity of the liner.

The exterior layers 18,20 add significantly greater fluid resistance than would be possible in the absence of these layers.

The fabric 10 comprises an additive to inhibit migration of any of the fabric to constituents into any fluid being contained/retained by a container or other structure constructed from the fabric 10.

Any suitable manufacturing processes and/or technique(s) may be used to manufacture the fabric 10. Existing bonding techniques may be employed to seal the fabric 10 at appropriate locations to create fluid storage containers or other required seals.

The base layer 12, the first coating layer 14 and the first exterior layer 18 are laminated in one pass, with the second coating layer 16 and second exterior layer 20 then laminated to the other side of the base layer 12 in a second pass. A suitable lamination temperature has been found to be approximately 290° C., but this can be varied if required. It is to be appreciated that the first and second exterior layers 18,20 are not extruded during the fabric production process, but are instead each supplied in a solid state and laminated onto the respective coating layers 14, 16 using appropriate heat and pressure.

Preferably, the lip of the die used to manufacture the fabric 10 extends beyond the edge of the fabric 10 being manufactured. This assists in bonding the fabric layers together, thereby maximizing the integrity of the fabric 10 being produced, particularly at the edge regions of the fabric 10.

The fabric according to the present invention may be used in practically any application requiring a generally impervious fabric. Being flexible, or at least semi-flexible, the fabric can be used in the manufacture of a multitude of fluid storage containers, including wine transportation containers, dam and pond liners and linings for water tanks.

The fabric can also be used in roofing membrane applications and other applications requiring a generally impervious or water-proof layer or barrier.

The fabric may also be used for other applications which do not necessarily utilize the highly impervious nature of the fabric. Such applications include sunlight blocking applications including a ceiling, roofing or building fabric for housing poultry. In such an application, the inner surface of the fabric may be black in colour to simulate night-time conditions favourable for the production of eggs. Advantageously, fabric 10 can be used to block all sunlight (and light from other sources), which has been found to stimulate egg production.

Finally, it is to be understood that various alterations, modifications and/or additions may be introduced into the construction and arrangement of the parts previously described without departing from the spirit or ambit of this invention.

What is claimed is:

1. A fabric, comprising:
a woven plastic base layer comprising a multi-filament scrim,
a first coating layer comprising a plastic applied to one side of the woven plastic base layer,
a second coating layer comprising a plastic applied to the other side of the woven plastic base layer,
a first exterior layer comprising a plastic applied to the first coating layer, and
a second exterior layer comprising a plastic applied to the second coating layer.

2. A fabric according to claim 1, wherein the woven plastic base layer comprises a woven polymer.

3. A fabric according to claim 2, wherein the woven plastic base layer comprises polypropylene.

4. (canceled)

5. A fabric according to claim 1, wherein the multi-filament scrim is between approximately 4×4 yarns/cm and approximately 10×10 yarns/cm.

6. A fabric according to claim 5, wherein the multi-filament scrim is approximately 5×5 yarns/cm.

7. A fabric according claim 1, wherein the multi-filament scrim comprises fibres with a thickness of between approximately 600 denier and approximately 2000 denier.

8. A fabric according to claim 7, wherein the multi-filament scrim comprises fibres with a thickness of approximately 1000 denier.

9. A fabric according to claim 1, wherein the woven plastic base layer comprises a wax additive.

10. A fabric according to claim 1, wherein the woven plastic base layer comprises a UV stabilizer additive.

11. A fabric according to claim 1, wherein the woven plastic base layer comprises a colour additive.

12. A fabric according to claim 1, wherein the plastic in each of the first coating layer and second coating layer comprises a polymer.

13. A fabric according to claim 12, wherein each of the first coating layer and second coating layer comprises:
a first sub-layer comprising a polypropylene co-polymer, the first sub-layer being bonded to the woven plastic base layer;
a second sub-layer comprising polypropylene and polyethylene applied to the first sub-layer; and
a third sub-layer comprising low-density polyethylene applied to the second sub-layer.

14. A fabric according to claim 1, wherein each of the first and second coating layers has a thickness of approximately 70 microns.

15. A fabric according to claim 14, wherein each first sub-layer has a thickness of approximately 25 microns, each second sub-layer has a thickness of approximately 25 microns and each third sub-layer has a thickness of approximately 20 microns.

16. A fabric according to claim 1, wherein the first coating layer and second coating layer are co-extruded.

17. A fabric according to claim 1, wherein the plastic in each of the first and second exterior layers comprises a polymer.

18. A fabric according to claim 17, wherein the polymer in each of the first and second exterior layers comprises polyethylene.

19. A fabric according to claim 18, wherein the polyethylene in each of the first and second exterior layers is a low-density polyethylene.

20. A fabric according to claim 1, wherein one of the first and second exterior layers is black in colour and the other of first and second layers is transparent.

21. A fabric according to claim 1, wherein the first and second exterior layers comprise a UV stabilizer additive.

22. A fabric according to claim 1, wherein each of the first and second exterior layers has a thickness of approximately 70 microns.

23. A fabric according to claim 1, further comprising an additive to inhibit migration of a fabric constituents from the fabric.

24. A fabric according to claim 1, wherein the first and second exterior layers are laminated onto, respectively, the first and second coating layers.

25. A fabric according to claim 1, wherein at least one of the first and second exterior layers comprises a matting additive.

26. A method of manufacturing a fabric according to claim 1.

27. A method of manufacturing a fabric according to claim 26, wherein the woven plastic base layer, the first and second coating layers and the first and second exterior layers occurs are laminated at a temperature of approximately 290° C.

28. A method of manufacturing a fabric according to claim 27, wherein the first coating layer and first exterior layer are laminated to one side of the woven plastic base layer in a first pass and the second coating layer and second exterior layer are laminated to the other side of the woven plastic base layer in a second pass.

29. A fabric according to claim 1, when used in the manufacture of one or more of a fluid holding container, a dam liner, a pond liner, a roofing membrane, a roof, a ceiling and a building structure.

30. (canceled)
